(19) United States
(12) Patent Application Publication
(10) Pub. No.: US 2012/0222524 A1
(43) Pub. Date: Sep. 6, 2012

(54) Ratcheting Hand Tool

(75) Inventor: Charles Floyd, San Francisco, CA (US)

(73) Assignee: ABSOLUTELYNEW, INC., San Francisco, CA (US)

(21) Appl. No.: 13/411,962

(22) Filed: Mar. 5, 2012

Related U.S. Application Data
(60) Provisional application No. 61/448,732, filed on Mar. 3, 2011.

(51) Int. Cl. B25B 13/46; B25F 1/00; B25B 15/04

(52) U.S. Cl. 81/60

(57) ABSTRACT

A ratcheting hand tool, comprising a handle, a first bit holder oriented along the longitudinal axis of said handle, located at one end of said handle, a second bit holder positioned toward the opposite end said first bit holder, said second bit holder positioned within said handle, with the axis of said second bit holder oriented perpendicularly to the longitudinal axis of said handle, said second bit holder further comprising a ratchet mechanism, and a removable tool bit, comprising a shaft that can be securely inserted into, and compatible with, said first and second bit holders. The tool bit can be inserted into a second bit holder in the handle, with the shaft functioning as a torque bar.

### CROSS-REFERENCE TO RELATED APPLICATIONS

61/448,732

### FEDERALLY SPONSORED RESEARCH

NONE

### SEQUENCE LISTING

NONE

### BACKGROUND OF THE INVENTION

Hand held drivers have been generally known in the art for some time. However, due to the general axial alignment of the bit and the handle, it is often difficult for the user to exert sufficient torque on a work piece such as a nut.

Prevailing hand tool designs have attempted to mitigate this problem by providing the handle with a segment that is pivoted from an axially aligned position to a generally transverse position relative to the axis of the handle. However, these designs often require additional parts in order to achieve the desired function.

Therefore it is desirable to provide an adjustable handle configuration that effectively integrates the torque bar to the multi-configuration handle of the tool.

### SUMMARY OF THE INVENTION

The present invention is directed to a hand held tool having a handle that can be oriented as a torque bar with a ratchet built into the handle. The invention can be described as a ratcheting hand tool, comprising a handle, a first bit holder oriented along the longitudinal axis of said handle, located at one end of said handle, a second bit holder positioned toward the opposite end from said first bit holder, said second bit holder positioned within said handle, with the axis of said second bit holder oriented perpendicularly to the longitudinal axis of said handle, said second bit holder further comprising a ratchet mechanism, and a removable tool bit, comprising a shaft that can be securely inserted into, and compatible with, said first and second bit holders. When the tool bit is inserted into the second bit holder in the handle, the shaft functions as a torque bar.

An object of the present invention is to provide a handle that can be reconfigured as a ratcheted torque bar readily accessible for the user and can be easily and efficiently reconfigured to accept different size and types of bits.

Yet another object of the present invention is to provide a hand held driver having a strong and durable handle housing that is capable of withstanding and deliver the additional torque load to which the driver may be subjected.

Yet another object of the present invention is to provide a simpler ratcheting mechanism that does not require a directional control switch, but instead has the user reverse the physical orientation of the handle in order to reverse the direction of the ratchet.

### DRAWINGS

FIG. 1 shows the nut driver tool in its standard conventional configuration;

FIG. 2 shows the tool in its various separate pieces;

FIG. 3 shows an alternate view of the various pieces of the present invention;

FIG. 4 shows the configuration in which the handle operates as a ratcheting torque bar to loosen a screw or a nut;

FIG. 5 shows the tool with examples of the different possible attachments that can be connected to the handle.

FIG. 6 shows the configuration of the tool with the organizer attachment for storage of the handle and a set of the shanks containing various sizes and types of drivers.

FIG. 7 shows an embodiment where the tool is comprised of an integrated handle and nut driver socket, with a ratcheting second nut driver positioned at the handle.

### DETAILED DESCRIPTION OF THE INVENTION

The first preferred embodiment of the tool comprises a handle 1, a first bit holder positioned at one end of said handle 2 oriented along the longitudinal axis of the handle, a second bit holder with a ratcheting mechanism 3 imbedded toward the opposite end of the first bit holder, with the second bit holder's axis oriented perpendicularly to the longitudinal axis of the handle, and an interchangeable tool bit comprising of a shank 6, a shaft 4, and a tip 5 can be inserted to either bit holders 2 and 3.

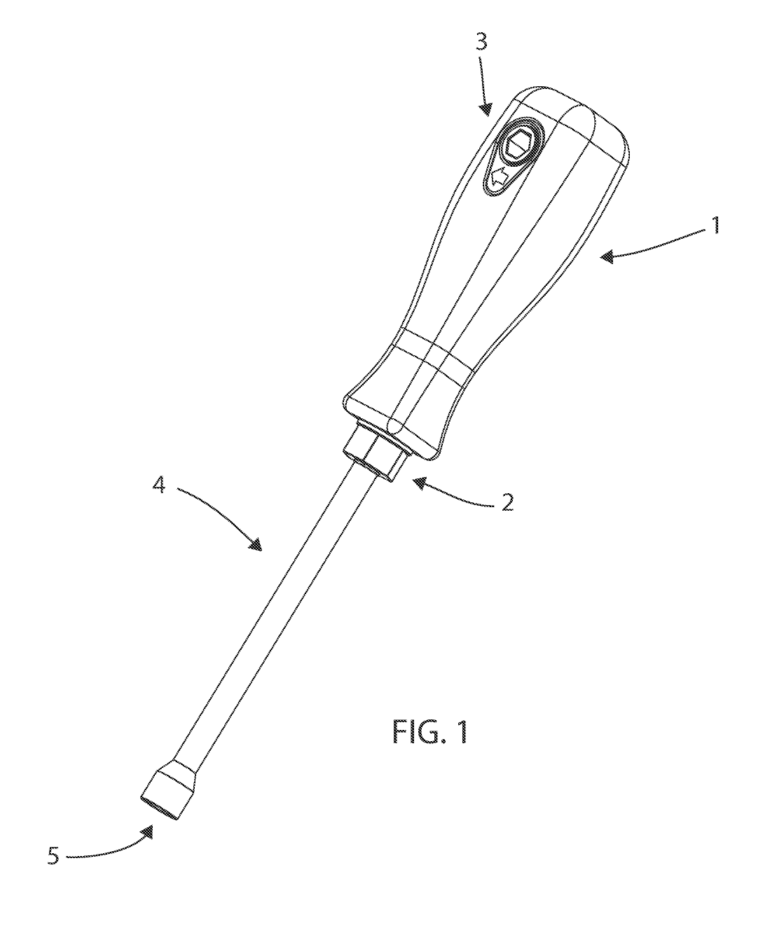

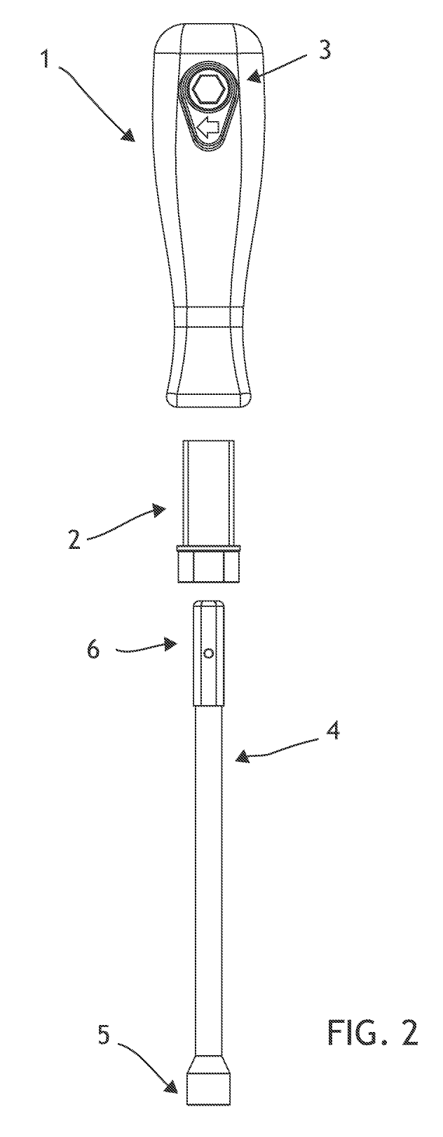

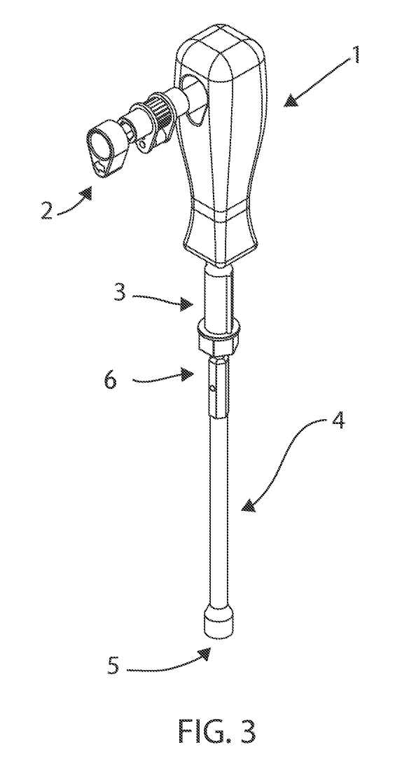

FIG. 1 shows the hand tool in the traditional hand tool configuration, with FIGS. 2 and 3 showing the exploded view of the tool, further showing all the separate elements of the tool.

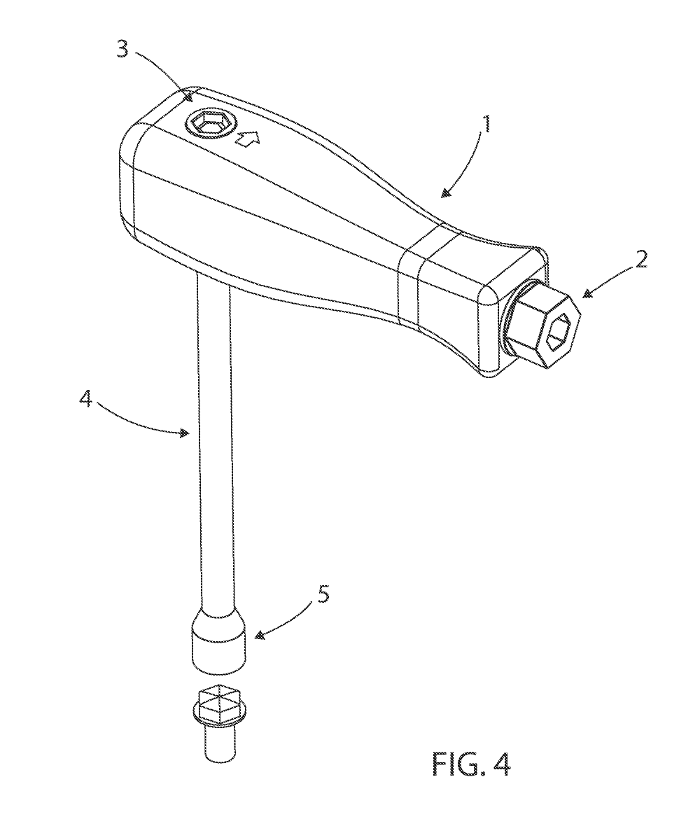

FIG. 4 shows the alternate form of the tool when the shaft is inserted to the second bit holder 3, with the tool 5 perpendicularly oriented to the handle 1. This form is achieved by removing the shaft 4 from the handle 1, and inserting the said shaft 4 into the second bit holder 3 on the top part of the handle 1. Said handle 1 effectively becomes a torque bar for the shank. The direction of the ratcheting action can be altered by the orientation of the handle relative to the shaft 4, with one side goes clockwise and reversing the handle would in turn reverse the direction of the ratchet to counter-clockwise. The benefit of the design is that it eliminates the need for any mechanism to reverse the direction of the ratchet, therefore simplifying the design over the prior art. Additionally, another shaft can be inserted to the first bit holder 2 as a handle extension to provide the user with even more torque.

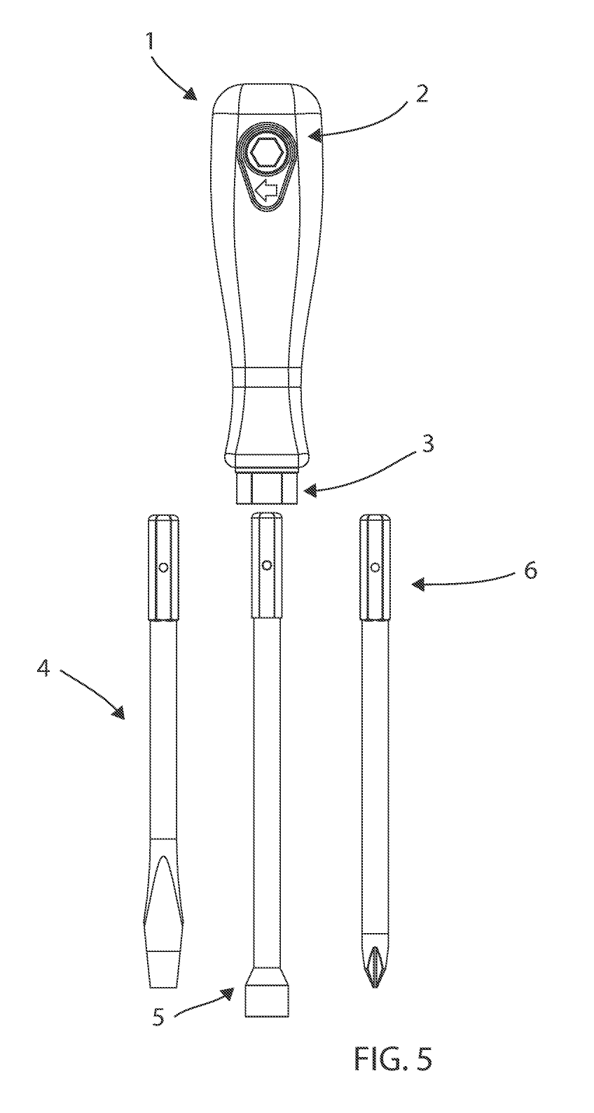

Turning to FIG. 5, the tool can be equipped with various different types of tips, including but not limited to nut driver sockets, screwdriver bits, and any other tools well known in the art such as a hammer.

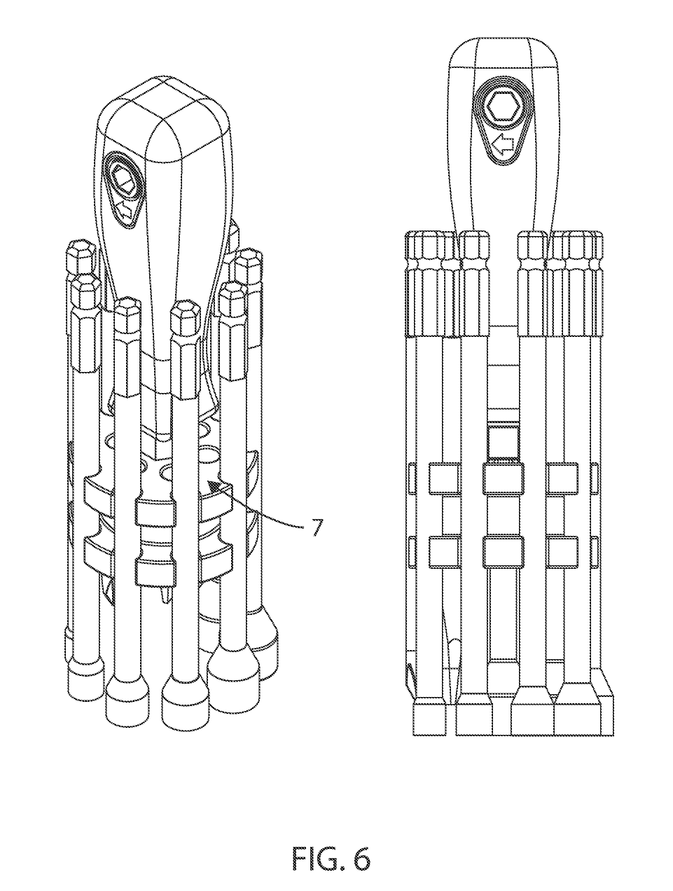

Turning to FIG. 6, the tool also further comprises of an organizing ring 10 that functions as a practical storage for the available shanks with different types and sizes of drivers for use. The organizer comprises of a ring shaped shank holders, with a central attachment portion that can be inserted to the handle in an identical manner as the other drivers.

The bit holder 2 can include a magnet inside to further secure the shank 6, or alternatively be a chuck, or any other means of securely holding the shank well known in the industry.

The shape of the shank 6 can be made of multiple varieties, including but not limited to straight shank, hex shank, SDS shank, triangle shank, morse taper shank, and square shank. As long as the shape of the shank is compatible with the shape of the bit holders 2 and 3, any type of shank can be made compatible with the present invention, and should be immediately clear to a person having ordinary skill in the art. The preferred embodiment of the present invention is in the form of hexagonal shank that can fit a chuck of an electric drill and other conventional handles with interchangeable shafts. Nevertheless, it should also be clear to someone having ordinary skill in the art that the shape of the shank comes in the form of a proprietary shape that is compatible with the bit holders, and the present patent encompasses this variation as well.

The location of the second bit holder 3 relative to the handle 1 is governed by the underlying principle of torque. By placing the second bit holder at the end of the handle 1, and orienting the axis of the bit holder perpendicular to the longitudinal axis of the handle, the optimum amount of torque can be delivered through the hand tool. It should be understood that the placement of the second bit holder therefore highly depends on the shape of the handle. Someone skilled in the art will be able to figure out the optimum placement of the second bit holder with respect to the handle by a simple calculation of torque physics.

The shape and cross-sectional geometry of the handle 1 can take any form commonly found in the field. The present disclosure is not meant to be limited to conventionally shaped handles, but further encompass other designs found in the field including but not limited to T-handles and L-handles.

The handle can be decorated with some indicator informing the user of the direction of the ratchet in the second bit holder 3 upon quick inspection of the handle. The indicator can be in the form of a plurality of colors, directional arrows, illustrations, diagrams, and the like.

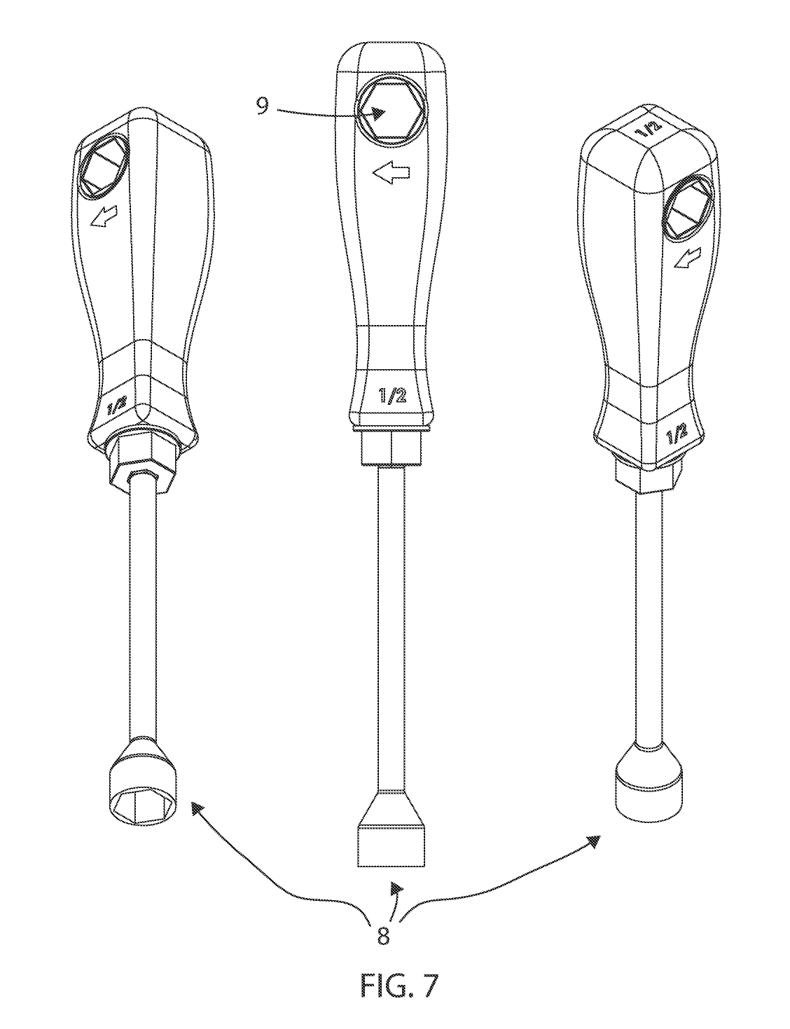

Turning to FIG. 7, an alternate embodiment of the present invention comes in the form of a conventional nut driver 8 with a second nut driver with a ratchet 9 imbedded in the handle of the tool. The second nut driver 9, located at the end of the handle opposite of the shaft, is oriented perpendicularly to the longitudinal axis of the tool. Both nut drivers in this form are of the same size. In this form, the shank is permanently attached to the handle. The user then simply grips the tool on the shaft portion and uses the driver socket on the handle to deliver more torque to the nut.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A ratcheting hand tool, comprising:
a. A handle;
b. A first bit holder having its axis oriented parallel to the longitudinal axis of said handle, located at one end of said handle;
c. A second bit holder positioned toward the opposite end of the handle from said first bit holder, said second bit holder positioned within said handle, with the axis of said second bit holder oriented perpendicularly to the longitudinal axis of said handle, said second bit holder further comprising a ratchet mechanism;
d. A removable tool bit, comprising a shaft that can be securely inserted into, and compatible with, said first and second bit holders.

2. A ratcheting hand tool of claim 1, where said first bit holder further comprises a ratcheting mechanism.

3. A ratcheting hand tool of claim 1, where said tool bit is a socket.

4. A ratcheting hand tool of claim 1, where said tool bit is a screw driver.

5. A ratcheting hand tool of claim 1, where said tool bit is a hammer.

6. A ratcheting hand tool of claim 1, where at least one bit holder is a chuck.

7. A ratcheting hand tool of claim 6, where said chuck is a collet.

8. A ratcheting hand tool, comprising:
a. A handle;
b. A tool bit having a shaft permanently affixed to said handle;
c. A nut driver socket positioned near the end of said handle opposite the tool bit, with said nut driver's axis oriented perpendicularly to the longitudinal axis of said handle, said nut driver socket further comprising a ratchet.

9. A ratcheting hand tool of claim 8, where the permanently affixed shaft further comprises a ratcheting mechanism.
